(19) United States
(12) Patent Application Publication
(10) Pub. No.: US 2017/0114219 A1
(43) Pub. Date: Apr. 27, 2017

(54) POLYETHER SULFONE ULTRAFINE POWDER AND USE THEREOF, COATING CONTAINING POLYETHER SULFONE ULTRAFINE POWDER AND PREPARATION METHODS THEREOF

(71) Applicant: Zhiling ZENG, Foshan (CN)

(72) Inventors: Zhiling ZENG, Foshan (CN); Wenbo LIANG, Foshan (CN)

(21) Appl. No.: 15/120,738

(22) PCT Filed: Jun. 30, 2014
(86) PCT No.: PCT/CN2014/081185

§ 371 Date: Aug. 22, 2016

(30) Foreign Application Priority Data
Apr. 3, 2014 (CN) 201410133724.3

(51) Int. Cl. C08L 81/06; C08K 3/40; C09D 5/08; C09D 181/06

(52) U.S. Cl. CPC C08L 81/06; C09D 181/06; C08K 3/40; C09D 5/08

(57) ABSTRACT

Polyether sulfone ultrafine powder having a particle size larger than 0.1 μm and smaller than or equal to 5 μm and a coating having the ultrafine powder added thereto are disclosed. The polyether sulfone ultrafine powder is easy to be mixed uniformly with other materials and has better flowing property and higher affinity for water, is unlikely to be clustered in a solvent, and is stable in performance after being dissolved. In addition, less organic solvent would be used when the coating is prepared. Besides, when the polyether sulfone ultrafine powder is used as plastic and glass modifiers, the surface finish of the obtained plastic plates and glass products is improved.

### FIELD OF THE INVENTION

The present invention relates to a polyether sulfone material, and more particularly to the use polyether sulfone material in preparing coating materials and as plastic and glass modifiers, and to a coating material utilizing said polyether sulfone material.

### BACKGROUND OF THE INVENTION

Polyether sulfone (PES) is a kind of thermoplastic high polymer material with superior comprehensive properties, which is developed by Imperial Chemical Industries in 1972. Polyether sulfone is one of the special and widely used engineering plastic in recent years, which has excellent heat resistance, physical and chemical properties (e.g. easy tinting, high strength, corrosion resistance, a wide range of PH application, antioxidant etc.) and insulating properties.

Especially, as polyether sulfone has the excellent properties of heat resistance, steam resistance, corrosion resistance, easy tinting and nontoxicity, it could be used as adhesion agent of coating material to prepare non-stick coating materials.

However, due to the hydrophobic property of polyether sulfone, the coating material at present, in which polyether sulfone is used as the main components, basically adopts organic solvent as dilution solvent for polyether sulfone. The use of organic solvent not only causes high cost, but also brings environmental pollution to a great extent. In order to reduce the production cost and solve environmental problems, there is a pressing need to develop a water soluble polyether sulfone coating material system.

Take non-stick coating material containing polyether sulfone disclosed by Patent Literature 1 as an example, even the content of surfactant (Triton X-100) and anti-blooming agent (DC Q2-5211), which are essentially organic solvents, in the coating material is not taken into consideration, the coating material disclosed by the embodiments 1-6 in Patent Literature 1 already contains 30 parts by weight to 40 parts by weight of organic solvents.

Likewise, the water soluble polyether sulfone coating material disclosed by Patent Literature 2 reduce the dosage of organic solvent, while the amount of organic solvent still accounts for 30 parts by weight of the total coating amount.

In order to improve the hydrophilic property of polyether sulfone, so far scientific researchers in the field introduce hydrophilic groups (such as acrylic acid) to polyether sulfone (PES) chemical structure and adopt chemical modification, plasma modification, photochemical modification and radiation grafting modification technical means (See non-Patent Literature 1 for details). However, these methods can not reduce the production cost of costing material effectively, and it may significantly raise the production cost in some way. In addition, as a new hydrophilic group is introduced, it may cause changes in properties of polyether sulfone so that the polyether sulfone could not play a good role in adhesion intended.

As polyether sulfone has the excellent properties of heat resistance, creep resistance and light weight, it is widely used as plastic and glass modifiers in existing technology. It would improve the heat resistance property, toughness and strength of plastic when polyether sulfone is used as plastic modifiers, for example, hydroxyl-containing polyether sulfone is added into epoxy resin and acts as plastic modifiers to gets rid of deficiencies of poor toughness and low heat resistance; also, polyether sulfone could be used in Bisphenol A type cyanate ester resin system for modification to strengthen its toughness, and the fracture toughness property of plastics systems obtained is 4 times than unmodified. However, in existing technology, when polyether sulfone is used for plastic modifying, the plastic plate obtained has a surface covered with apparently jutting granules, thus affecting application of polyether sulfone in the field which requires good surface finish.

There are similar problems with glass modifiers. Polyether sulfone has the excellent properties of easy tinting to metal substrate, high strength and corrosion resistance. When polyether sulfone is used for glass modifying, it is coated on the substrate to be processed by electrostatic spraying, after curing and film-forming at 400° C., it can replace the traditional high-temperature glass-lined technology at 800-900° C., which can prolong the life of device and decrease the technical difficulty of glass lining. In addition, the products obtained are more unbreakable and good acid and alkali corrosion resistance. However, the glass obtained with polyether sulfone has a surface covered with apparently jutting granules, which greatly decrease the quality of the glass.

Therefore, there is a pressing need for those skilled in the field to develop a polyether sulfone material with excellent hydrophilic property and prepare a water soluble coating material with the polyether sulfone material. Meanwhile, plastic and glass with satisfied surface finish would be obtained by using the polyether sulfone material as modifier.

### LIST OF LITERATURE CITED

Non-Patent Literature

Study on improving the hydrophilic property of polyether sulfone powder by γ radiation grafted acrylic acid. Journal of radiation research and technology 23(6), December, 2005

Patent Literature

1. Chinese patent application 200810034222.X, publication date: Sep. 9, 2009.

2. Chinese patent application 200810006647.X, publication date: Aug. 5, 2009.

### SUMMARY OF THE INVENTION

The present invention provides a micro-grade polyether sulfone ultrafine powder, and it is first found that said polyether sulfone ultrafine powder does not only improve the hydrophilic property of polyether sulfone, but also achieve unexpected technical effects in preparing water soluble coating material or when it is used as plastic and glass modifiers (such as reducing the dosage of organic solvent in the coating material significantly or greatly improving the surface finish of plastic plate and glass).

Based on the above studies by the inventor, an objective of the present invention is to provide a polyether sulfone ultrafine powder, wherein its particle size is larger than 0.1 μm and smaller than or equal to 5 μm.

Another objective of the present invention is to provide the use of polyether sulfone ultrafine powder in preparing water-soluble coating or use as plastic and glass modifiers.

Another objective of the present invention is to provide a water-soluble coating, prepared by the above-mentioned polyether sulfone ultrafine powder, wherein the coating comprises the following ingredients:

polyether sulfone ultrafine powder 20-30 parts by weight;

polytetrafluoroethylene resin 5-15 parts by weight;

color paste 5-15 parts by weight;

water 30-50 parts by weight; and

organic solvent 10-20 parts by weight.

Specifically, the technical solution of the present invention will be explained by the disclosure in the following paragraphs [0027] to [0064].

A polyether sulfone ultrafine powder, wherein its particle size is larger than 0.1 μm and smaller than or equal to 5 μm.

The polyether sulfone ultrafine powder according to paragraph [0027], wherein its particle size is larger than 0.1 μm and smaller than or equal to 2 μm.

The polyether sulfone ultrafine powder according to paragraph [0028], wherein its particle size is larger than 0.1 μm and smaller than or equal to 1 μm.

The polyether sulfone ultrafine powder according to paragraph [0029], wherein its particle size is larger than 0.1 μm and smaller than or equal to 0.5 μm.

The polyether sulfone ultrafine powder according to paragraph [0030], wherein its particle size is larger than 0.1 μm and smaller than or equal to 0.2 μm.

The polyether sulfone ultrafine powder according to paragraph [0031], wherein its particle size is larger than 0.1 μm and smaller than or equal to 0.15 μm.

The polyether sulfone ultrafine powder according to any of the paragraphs [0027] to [0032], wherein its particle size is 0.13 μm.

The use of polyether sulfone ultrafine powder according to any of paragraphs [0027] to [0033] in preparing water-soluble coating.

The use of polyether sulfone ultrafine powder according to any of paragraphs [0027] to [0033] as plastic modifier.

The use of polyether sulfone ultrafine powder according to any of paragraphs [0027] to [0033] as glass modifier.

The use according to any of paragraphs [0035] or [0036], wherein 10-30 parts by weight, preferably 15-25 parts by weight of the polyether sulfone ultrafine powder according to any of paragraphs [0027] to [0033] is added into the plastic or glass corresponding to the weight of the plastic or glass to be modified.

A water-soluble coating, prepared by the polyether sulfone ultrafine powder according to any of paragraphs [0027] to [0033], wherein the coating comprises the following ingredients:

polyether sulfone ultrafine powder 20-30 parts by weight;

polytetrafluoroethylene resin 5-15 parts by weight;

color paste 5-15 parts by weight;

water 30-50 parts by weight; and

organic solvent 10-20 parts by weight.

The water-soluble coating according to paragraphs [0038] to [0043], wherein the coating comprises the following ingredients:

polyether sulfone ultrafine powder 23-27 parts by weight;

polytetrafluoroethylene resin 8-12 parts by weight;

color paste 8-12 parts by weight;

water 35-45 parts by weight; and

organic solvent 13-17 parts by weight.

The water-soluble coating according to paragraphs [0038] to [0043] or paragraphs [0044] to [0049], wherein the color paste is at least one selected from titanium green, titanium yellow, titanium white, iron oxide black and carbon black, preferably titanium green.

The water-soluble coating according to any of paragraphs [0038] to [0043], paragraphs [0044] to [0049], and paragraph [0050], wherein the water is tap water, distilled water, double distilled water or ultrapure water.

The water-soluble coating according to any of paragraphs [0038] to [0043], paragraphs [0044] to [0049], paragraph [0050] and paragraph [0051], wherein the organic solvent is at least one of ketone, amine, acid amide, alcohol, acid, ether and ester.

The water-soluble coating according to paragraph [0052], wherein the ketone is acetone, isopropyl-ketone, pyrrolidone, hexanone, cyclohexanone or butanone; the amine is alcohol amine, sulfone amine or dimethylamine; the acid amide is acetamide, dimethylformamide or dimethylacetamide; the alcohol is propyl alcohol, isopropanol, butanol, ethanediol, propanediol, butanediol or diethylene glycol; the acid is methanoic acid, acetic acid, propionic acid, ethanedioic acid, malonic acid or benzoic acid; the ether is diethyl ether, propyl ether, isopropyl ether, ethylene glycol monomethyl ether, ethylene glycol monoethyl ether, ethylene glycol butyl ether, diethylene glycol butyl ether, propylene glycol monomethyl ether or propylene glycol monoethyl ether; the ester is γ-butyrolacton.

The water-soluble coating according to paragraph [0052], wherein the organic solvent is a mixed solution of acetamide and pyrrolidone with the volume ratio of 1:1.

The water-soluble coating according to any of paragraphs [0038] to [0043], paragraphs [0044] to [0049], and paragraph [0050], paragraph [0051], paragraph [0052], paragraph [0053] and paragraph [0054], wherein the water-soluble coating further comprises one or a mixture of anti-adhesion agent, thickening agent, dispersant, surfactant, anti-blooming agent, anti-foaming agent, and flatting agent.

A method of preparing the polyether sulfone ultrafine powder according to any of paragraphs [0027] to [0033], wherein the method comprises the step of grinding the polyether sulfone powder or particle by a grinding device with the presence of an emulsifier.

The method according to paragraph [0056], wherein the emulsifier is OP-21 or Triton X-100.

The method according to paragraph [0056] or paragraph [0057], wherein the grinding device is a levigator or ceramic ball.

The method according to any of paragraph [0056], paragraph [0057] and paragraph [0058], wherein the grinding lasts for 178 hours to 260 hours.

A method of preparing the water-soluble coating according to any of paragraphs [0038] to [0043], paragraphs [0044] to [0049], and paragraph [0050], paragraph [0051], paragraph [0052], paragraph [0053], paragraph [0054] and paragraph [0055], wherein the method comprises the following steps of: mixing evenly the polyether sulfone ultrafine powder according to any of paragraphs [0027] to [0033], polytetrafluoroethylene resin, color paste, water and organic solvent in a container to obtain a mixture; then placing said container in a high-speed dispersion machine and dispersing said mixture by the high-speed dispersion machine; then filtrating the dispersed mixture by a 200-400 meshes sieve; and adding polytetrafluoroethylene resin to the filtrated mixture to obtain said water-soluble coating after mixing said mixture by a mixer.

The method according to paragraph [0060], wherein the mixture is dispersed by the high-speed dispersion machine at a speed of 800-960 revolutions per minute.

The method according to paragraphs [0060] or paragraph [0061], wherein the mixture is dispersed by the high-speed dispersion machine for 30 minutes.

The method according to any of paragraphs [0060], paragraph [0061] and paragraph [0062], wherein the mixer stirs the mixture at a speed of 60-100 revolutions per minute after the polytetrafluoroethylene resin was added to the filtrated mixture.

The method according to any of paragraph [0060], paragraph [0061], paragraph [0062] and paragraph [0063], wherein the mixer stirs the mixture for 20 minutes after the polytetrafluoroethylene resin was added to the filtrated mixture.

Compared to the polyether sulfone in the existing technology, polyether sulfone ultrafine powder within the range of particle size of the present invention would not only keep the advantage of high temperature resistance, high strength performance and corrosion resistance, but also have the following advantages: more easy to well-mixed with other material (such as plastic, glass and polytetrafluoroethylene resin etc.), excellent flowing property, more easy to blend with water (i.e. increasing hydrophilic property). Furthermore, agglomerates are not easily formed with polyether sulfone in the solvent (the polyether sulfone is more stable when dissolved in the solvent).

Meanwhile, the water soluble coating material prepared by the polyether sulfone ultrafine powder of the present invention significantly reduce the dosage of organic solvent (the dosage of organic solvent in the water soluble coating material accounts for 25 parts by weight at most in the present invention). Besides, the surface finish of the plastic and glass is significantly improved when the polyether sulfone ultrafine powder of the present invention is used as a plastic and glass modifier.

### DETAILED DESCRIPTION OF PREFERRED EMBODIMENTS

In one embodiment of the present invention, the particle size of polyether sulfone ultrafine powder is larger than 0.1 μm and smaller than or equal to 5 μm.

In one preferred embodiment of the present invention, the particle size of polyether sulfone ultrafine powder is larger than 0.1 μm and smaller than or equal to 2 μm.

In one further preferred embodiment of the present invention, the particle size of polyether sulfone ultrafine powder is larger than 0.1 μm and smaller than or equal to 1 μm, which is preferably larger than 0.1 μm and smaller than or equal to 0.5 μm, and more preferably is larger than 0.1 μm and smaller than or equal to 0.2 μm, and further more preferably is larger than 0.1 μm and smaller than or equal to 0.15 μm, particularly preferred is 0.13 μm.

The polyether sulfone ultrafine powder of the present invention could be utilized to prepare water-soluble coating. As it reduces the dosage of organic solvent in the water-soluble coating material significantly, thus greatly alleviating environmental pollution and reducing the production cost of water-soluble coating material.

In one preferred embodiment of the present invention, a water-soluble coating material prepared by the polyether sulfone ultrafine powder of the present invention is disclosed. The coating comprises the following ingredients:

polyether sulfone ultrafine powder 20-30 parts by weight;

polytetrafluoroethylene resin 5-15 parts by weight;

color paste 5-15 parts by weight;

water 30-50 parts by weight; and

organic solvent 10-20 parts by weight.

In one preferred embodiment of the present invention, a water-soluble coating material prepared by the polyether sulfone ultrafine powder of the present invention is further disclosed. The coating comprises the following ingredients:

polyether sulfone ultrafine powder 23-27 parts by weight;

polytetrafluoroethylene resin 8-12 parts by weight;

color paste 8-12 parts by weight;

water 35-45 parts by weight; and

organic solvent 13-17 parts by weight.

The term “color paste” in the context of the present invention refers to a nontoxic concentrated graining paste used to tint the coating. Types of the color paste are not restricted in the present invention, preferably water-based color paste. According to the expected color of the coating material, the color paste of the present invention is at least one selected from titanium green, titanium yellow, titanium white, iron oxide black and carbon black, preferably titanium green.

The water used for preparing water-soluble coating material of the present invention may be tap water, distilled water, double distilled water or ultrapure water.

The organic solvent in the context of the present invention refers to one or more of the following solvent: ketone, such as acetone, isopropyl-ketone, pyrrolidone (particularly N-methyl pyrrolidone), hexanone, cyclohexanone or butanone; amine, such as alcohol amine, sulfone amine or dimethylamine; acid amide, such as acetamide, dimethylformamide or dimethylacetamide; alcohol, such as propyl alcohol, isopropanol, butanol, ethanediol, propanediol, butanediol or diethylene glycol; acid, such as methanoic acid, acetic acid, propionic acid, ethanedioic acid, malonic acid or benzoic acid; ether, such as diethyl ether, propyl ether, isopropyl ether, ethylene glycol monomethyl ether, ethylene glycol monoethyl ether, ethylene glycol butyl ether, diethylene glycol butyl ether, propylene glycol monomethyl ether or propylene glycol monoethyl ether; ester, such as γ-butyrolacton. The preferred organic solvent of the present invention is a mixed solution of acetamide and pyrrolidone with the volume ratio of 1:1.

As the polyamide-imide (PAI) costs more than 3 times of polyether sulfone (PES) ultrafine powder, it would greatly reduce the production cost when polyether sulfone (PES) ultrafine powder is used. In addition, as the polyether sulfone ultrafine powder within the range of particle size of the present invention is not easy to form agglomerates when it is dissolved in water-based solvent, the obtained water-soluble coating material can maintain stable performance after a long-term placement. Meanwhile, compared to the traditional polyamide-imide coatings, the water-soluble coating material of the present invention has better alkali resistance, and the film coated by the water-soluble coating material of the present invention has a higher surface hardness. Therefore, the water-soluble coating material prepared by the present invention can substitute for the traditional the polyamide-imide (PAI) coatings and used as the coating of non-stick cookware and related products.

As a large amount of water is used as dissolvent in the coating material prepared by the present invention, it may to a remarkable extent improve the environmental pollution caused by organic solvent.

In one embodiment of the present invention, the polyether sulfone ultrafine powder of the present invention is used as plastic and glass modifier and so on.

When the polyether sulfone ultrafine powder of the present invention is used as plastic and glass modifier, the inventor first discovers that the use of the polyether sulfone ultrafine powder within the range of particle size of the present invention would not only retain the benefits of polyether sulfone as plastic and glass modifier in traditional technologies (such as improving the heat resistance, strength and toughness of the plastic; and prolonging the life of glass-lined equipment and solving the problems of friability and non-corrosion), but also greatly improve the surface finish of plastic and glass, so that the modified plastic and glass can be applied in a wide range of areas.

In a preferred embodiment of the present invention, 10-30 parts by weight, preferably 15-25 parts by weight of the polyether sulfone ultrafine powder is added to the plastic or glass corresponding to the weight of the plastic or glass to be modified.

The polyether sulfone ultrafine powder of the present invention can be prepared by conventional methods, for example, with the presence of emulsifier (such as OP-21 produced by Shanghai Shuangda Chemical Co., Ltd.), the polyether sulfone ultrafine powder of the present invention will be obtained by conducting water-grinding ultrafine treatment on polyether sulfone powder/particles and water with a levigator, or by settling precipitates from the solution and dehydrating by conventional methods (such as molecular sieve).

As an exemplary method, the polyether sulfone ultrafine powder of the present invention can be prepared by the following steps: first pre-pulverizing polyether sulfone powder with a particle size of 550 μm to polyether sulfone powder with a particle size of 54.5 μm; adding Triton X-100 to the pulverized powder and grind the mixture with a ceramic ball for 178 hours, thus obtaining polyether sulfone ultrafine powder with a particle size of less than 5 μm. The longer the grinding time, the smaller the particle size. In order to meet the minimum requirements of polyether sulfone ultrafine powder of the present invention, the grinding time with the ceramic ball lasts for 260 hour at most.

The water-soluble coating material of the present invention can be prepared by the following steps: mixing evenly the polyether sulfone ultrafine powder, color paste, water and organic solvent in a container and obtain a mixture; then placing said container in a high-speed dispersion machine and dispersing said mixture at a speed of 800-960 revolutions per minute by the high-speed dispersion machine for 30 minutes; and then filtrating the dispersed mixture by a 200-400 meshes sieve; adding a suitable proportional of polytetrafluoroethylene resin to the mixture and the mixer stirring the mixture at a low-speed (about 60-100 revolutions per minute) for 20 minutes, thus obtaining said water-soluble coating of the present invention.

When the water-soluble coating of the present invention is put into use, it can be used directly as monolayer non-stick coating (i.e. finished product can be obtained after single coating of the water-soluble coating), and it also be used as prime coating of double-layer fluororesin non-stick coatings (i.e. spraying the water-soluble coating on the workpiece and letting dry, then spraying the second layer fluororesin coating containing polyether sulfone).

According to the actual needs, the water-soluble coating of the present invention can be further added into other compositions, such as anti-adhesion agent, thickening agent, dispersant, surfactant, anti-blooming agent, anti-foaming agents, flatting agent or the combination of the above-mentioned compositions.

The polyether sulfone powder beyond the range of particle size of the present invention is used as a control, related performance test are performed on the polyether sulfone ultrafine powder of the present invention.

1. The Test of Miscibility with Water (i.e. Hydrophilic Property)

40 g-100 g of polyether sulfone ultrafine powder is added to 100 g of pure water that contains 1 wt % of wetting agent W22 (Worldwide Resin & Chemical (Guangdong) Co., Ltd.); and the mixture obtained is stirred at a low-speed of 100 revolutions per minute for 20 minutes, then stand still and subside, and stratification was observed. Corresponding to the total weight of polyether sulfone ultrafine powder added into the solution, it is rated as “Excellent” when sedimentation rate is less than 30 wt % (recorded as 8-10 points); it is rated as “Good” when sedimentation rate is larger than or equal to 30 wt % and less than 50 wt % (recorded as 5-7 points); it is rated as “Qualified” when sedimentation rate is larger than or equal to 50 wt % and less than 70 wt % (recorded as 2-4 points); it is rated as “Bad” when sedimentation rate is larger than 70 wt % (recorded as 0-1 points).

2. The Performance Test of Drying and Forming Film after the Polyether Sulfone Ultrafine Powder of the Present Invention is Made into a Coating

A coating is synthesized by polyether sulfone ultrafine powder of different particle sizes, then the coating is dried to form film at 180° C.-400° C.

The film is rated based on the following rating criteria when the coating is dried: it is recorded as 0-3 points and rated as “Bad” if the film turns yellow or cracks; it is recorded as 4-7 points and rated as “Qualified” if the film shows the original color and is flexible without fracture; it is recorded as 8-10 points and rated as “Excellent” if the film shows no discoloration and is flexible and smooth. The performance of drying and forming film prepared is evaluated according to the average points of observation group of 5 individuals.

3. the Test of Viscosity Performance (Flowing Property)

A coating is synthesized by polyether sulfone ultrafine powder of different particle sizes; then immerse the ANEST IWATA measuring cup into the coating at a temperature of 0° C.-60° C., making the upper edge of the measuring cup lower than the horizontal plane of the coating; at the time of picking up the ANEST IWATA measuring cup in an upright position, press the stopwatch and measure the time of outflow line breaking off for the first time; perform parallel determination for 3 times and take the average value. The shorter the time, the lower the viscosity, and the higher the flowing property, which means higher dispersion degree in the water of the polyether sulfone ultrafine powder used in the coating, and more uniformly the polyether sulfone ultrafine powder dispersed in the water.

4. Test of Organic Solvent Dosage

The organic solvent is dropped directly into 10 g of polyether sulfone ultrafine powder at 0° C.-60° C. Measure the amount of solvent which 10 g of polyether sulfone ultrafine powder required for complete dissolution (measured by weight in grams).

5. Test of Storage Stability of the Coating

A coating is synthesized by polyether sulfone ultrafine powder of the present invention. 25 kg of the coating is stored at a dry indoor environment without direct light to conduct the test of storage stability. When the stored coating turns up precipitation and agglomeration, roll the coating and observe the dispersion, it means unstable storage when it fails to be dispersed uniformly again, which should be deemed as storage failure, thus it can determine the days for effective storage (i.e. keeping effective storage) of the coating prepared by the polyether sulfone ultrafine powder of different particle sizes.

6. Test of Film Density and Film Compactness

A coating is synthesized by polyether sulfone ultrafine powder of the present invention. The coating is dried to form film at a high temperature of 180° C.-400° C. and tests are conducted on the film surface.

Observe the film surface under a microscope and measure the molecular space of the film surface (measured in μm). The bigger the space, the smaller the film density, the poorer the film compactness. When the space diameter between polyether sulfone ultrafine particles is less than 5 μm, a film of proper density could be obtained, which also has a good film compactness; when the space diameter between polyether sulfone ultrafine particles is larger than 5 μm, although a film could be formed, it has a low film density and poor film compactness; when agglomerates are formed among the polyether sulfone ultrafine particles, it is hard to form any film, or even a film is obtained, it has a poor film compactness.

7. The Performance Test of Corrosion Resistance

A coating is synthesized by polyether sulfone ultrafine powder of the present invention, The coating is dried to form film at a high temperature of 180° C.-400° C. and tests of corrosion resistance are conducted on the film.

A mixed solution of hydrochloric acid and water with the volume ratio of 1:1 or of sodium hydroxide and water with the volume ratio of 1:1 is used as test solution; pour the mixture into a container which is coated with the film, then heat the mixture at a temperature of 100° C., and record the time for corrosion occurrence of the film.

8. Test of Modification Level to Plastic

At the mixing stage before extrusion molding of plastic, and at a temperature of 110° C.-200° C., add the polyether sulfone ultrafine powder into the epoxy resin, which is used as plastic, mix the mixture until the polyether sulfone ultrafine powder and plastic are mutually dissolved; the plastic with polyether sulfone ultrafine powder is extruded into a 1 cm-thick plastic plate; check the surface finish of the plastic and evaluate it based on the following rating criteria: it is recorded as 0-3 points and rated as “Bad” if the plastic has a surface covered with apparently jutting granules; it is recorded as 4-7 points and rated as “Qualified” if the surface shows a little grittiness but not affecting the overall surface finish; it is recorded as 8-10 points and rated as “Excellent” if the surface is fine and smooth. The surface finish of the plastic obtained is evaluated according to the average points of observation group of 5 individuals.

9. Test of Modification Level to Glass

Polyether sulfone ultrafine powder of different particle sizes are directly added into the glass melt, which has been preheated to 400° C.; Stir the glass melt and manufacture glass lining in a molten state, and evaluate the products obtained based on the following rating criteria: it is recorded as 0-3 points and rated as “Bad” if the plastic has a surface covered with apparently jutting granules; it is recorded as 4-7 points and rated as “Qualified” if the surface shows a little grittiness but not affecting the overall surface finish; it is recorded as 8-10 points and rated as “Excellent” if the surface is fine and smooth, bright and translucent. The surface finish of the glass obtained is evaluated according to the average points of observation group of 5 individuals.

10. The Test of Miscibility with Polytetrafluoroethylene Resin Ultrafine Powder

As both polyether sulfone and polytetrafluoroethylene resin are inert material, in order to achieve the effects of mutually dissolved and modified, it is in high demand for the particle sizes of polyether sulfone ultrafine powder. Add polyether sulfone ultrafine powder of different particle sizes to the polytetrafluoroethylene resin in a molten state and stir the mixture evenly; and evaluate the mixture by taking that whether the polyether sulfone ultrafine powder can be adhered to the surface of polytetrafluoroethylene resin as a standard.

The present invention will be further elaborately explained by the following specified embodiments, while it should be understood that the scope of the present invention is not limited to the specific embodiments disclosed and described below.

### Exemplary Embodiment

According to the methods described above, the performance tests of polyether sulfone ultrafine powder are conducted, wherein:

(1) In the test of miscibility with water, 100 g of polyether sulfone ultrafine powder is added to 100 g of pure water that contains 1 wt % of wetting agent W22 (Worldwide Resin & Chemical (Guangdong) Co., Ltd.); and the mixture obtained is stirred at a low-speed of 100 revolutions per minute for 20 minutes, then stand still and subside, and whose stratification was observed. The measured miscibility of the polyether sulfone ultrafine powder and water is showed in the following Table 1.

It is found out that the polyether sulfone ultrafine powder within the particle sizes of the present invention has better hydrophilic performance.

(2) In performance test of drying and forming film, a coating is synthesized by polyether sulfone ultrafine powder of different particle sizes according to the following formulations:

polyether sulfone ultrafine powder 25 parts by weight;

polytetrafluoroethylene resin 10 parts by weight;

titanium green 10 parts by weight;

water 40 parts by weight;

a mixed solvent of acetamide-pyrrolidone with a volume ratio of 1:1 15 parts by weight.

Dry the above-mentioned coating to form film at 360° C., and evaluate the performance of drying and forming film according to the average points of observation group of 5 individuals. The results are listed in the following Table 1.

It is found out that the polyether sulfone ultrafine powder within the particle sizes of the present invention has better drying and film-forming performance than that of the polyether sulfone ultrafine powder beyond the range of the particle sizes of the present invention.

(3) In the Test of Viscosity Performance, a Coating is Synthesized by Polyether Sulfone Ultrafine Powder of Different Particle Size According to the Following Formulations:

polyether sulfone ultrafine powder 25 parts by weight;

polytetrafluoroethylene resin 10 parts by weight;

titanium green 10 parts by weight;

water 40 parts by weight; and

a mixed solvent of acetamide-pyrrolidone with a volume ratio of 1:1 15 parts by weight.

Test the above-mentioned coating at a temperature of 60° C., and list the time measured to break off in the following Table 1.

It is found out that the polyether sulfone ultrafine powder within the particle sizes of the present invention has better flowing property performance compared to that of the polyether sulfone ultrafine powder beyond the range of the particle sizes of the present invention, which suggests that the polyether sulfone ultrafine powder of the present invention has better and more uniform dispersion in the water.

(4) In the test of organic solvent dosage, a mixed solvent of acetamide-pyrrolidone with a volume ratio of 1:1 is dropped in 10 g of polyether sulfone ultrafine powder at a temperature of 20° C.

The organic solvent dosage measured is listed in the following Table 1 (measured in g). It is found out that the dosage of organic solvent for dissolving the polyether sulfone ultrafine powder within the particle sizes of the present invention significantly reduced compared to that of the polyether sulfone ultrafine powder beyond the range of the particle sizes of the present invention.

(5) In the test of storage stability of the coating, a coating is synthesized by polyether sulfone ultrafine powder of the present invention according to the following formulations:

polyether sulfone ultrafine powder 25 parts by weight;

polytetrafluoroethylene resin 10 parts by weight;

titanium green 10 parts by weight;

water 40 parts by weight; and

a mixed solvent of acetamide-pyrrolidone with a volume ratio of 1:115 parts by weight.

25 kg of the coating is stored at a dry indoor environment without direct light at a temperature of 20° C. to conduct the test of storage stability, and list the effective storage days recorded in the following Table 1.

It is found out that the polyether sulfone ultrafine powder within the particle sizes of the present invention has longer effective storage days than that of the polyether sulfone ultrafine powder beyond the range of the particle sizes of the present invention.

(6) In the test of film density and film compactness, a coating is synthesized by polyether sulfone ultrafine powder of the present invention according to the following formulations:

polyether sulfone ultrafine powder 25 parts by weight;

polytetrafluoroethylene resin 10 parts by weight;

titanium green 10 parts by weight;

water 40 parts by weight; and

a mixed solvent of acetamide-pyrrolidone with a volume ratio of 1:1 15 parts by weight.

The coating is dried to form film at a high temperature of 360° C. and tests are conducted on the film surface. List the molecular space of the film surface measured in the following Table 1.

It is found out that when the space diameter between polyether sulfone ultrafine particles is larger than 5 μm, as the space diameter increases, the molecular space also increases, and film density decreases and film compactness becomes poorer; when the space diameter between polyether sulfone ultrafine particles is less than 0.1 μm, it is easy to generate agglomeration among the polyether sulfone ultrafine particles and form irregular distributed aggregates because of the small particle size, thus affecting the film formation.

(7) In the performance test of corrosion resistance, a coating is synthesized by polyether sulfone ultrafine powder of the present invention according to the following formulations:

polyether sulfone ultrafine powder 25 parts by weight;

polytetrafluoroethylene resin 10 parts by weight;

titanium green 10 parts by weight;

water 40 parts by weight; and

a mixed solvent of acetamide-pyrrolidone with a volume ratio of 1:1 15 parts by weight.

Dry the above-mentioned coating to form film at 360° C., and test the film after formation. A mixed solution of hydrochloric acid and water with the volume ratio of 1:1 is used as test solution and heated at a temperature of 100° C. Record the time for corrosion occurrence of the film.

It is found out that the polyether sulfone ultrafine powder within the particle sizes of the present invention shows significantly longer time for corrosion occurrence.

(8) In the test of modification level to plastic, add the polyether sulfone ultrafine powder into the epoxy resin a temperature of 180° C., which is used as plastic. The surface finish of the plastic obtained is evaluated according to the average points of observation group of 5 individuals, and list the results recorded in the following Table 1.

It is found out that the plastic modified by polyether sulfone ultrafine powder within the particle sizes of the present invention has better surface finish than that modified by the polyether sulfone ultrafine powder beyond the range of the particle sizes of the present invention.

(9) Evaluate surface finish of the glass according to the average points of observation group of 5 individuals, and list the results recorded in the following Table 1.

It is found out that the glass modified by polyether sulfone ultrafine powder within the particle sizes of the present invention has better surface finish than that modified by the polyether sulfone ultrafine powder beyond the range of the particle sizes of the present invention.

Besides, the existing high temperature glass lining technique requires a curing temperature of 800-900° C., which causes huge energy consumption, equipment depreciation and severe damage. However, the curing temperature can be dropped to 400° C. when the glass is modified by the polyether sulfone ultrafine powder of the present invention. Therefore, it is not only energy-saving and environmental-protected, but also decreases the difficulty of the related glass lining technique. The glass lined products obtained is not fragile and has good acid and caustic corrosion resistance. In addition, compared to the products prepared by the existing technology, the glass lined products modified by the polyether sulfone ultrafine powder of the present invention could raise the end-use temperature from 160° C. to more than 300° C., thus obtaining fireproofing products more resistant to high temperatures.

(10) It is found out that as the particle size of polytetrafluoroethylene resin is larger than 5 μm, only when the particle size of polyether sulfone ultrafine powder is smaller than that of polytetrafluoroethylene resin, the polyether sulfone ultrafine powder can be evenly adhere to the surface of polytetrafluoroethylene resin in molten state and forms uniform compounds.

It can be been seen that from the following Table, the polyether sulfone ultrafine powder within the particle sizes of the present invention can be evenly adhere to the surface of polytetrafluoroethylene resin in molten state (although the he polyether sulfone ultrafine powder with the particle size of 5 μm may degrade in performance, it can still basically achieve uniform adhesion on the surface of polytetrafluoroethylene resin).

List the related data of the performance metrics obtained from the above-mentioned tests 1-10 on the polyether sulfone ultrafine powder of different particle sizes in the Table 1.

TABLE 1
the performance metrics comparison of the polyether sulfone ultrafine powder of different particle sizes.

| Test Item | Particle Size (μm) | | | | | | |
|---|---|---|---|---|---|---|---|
| (Unit) | 5.5 | 5 | 3 | 1 | 0.2 | 0.13 | 0.08 |
| 1 | 0 | 2 | 3 | 5 | 8 | 10 | 0 |
| 2 | 0 | 4 | 5 | 8 | 9 | 10 | 4 |
| 3 | 60 | 45 | 40 | 30 | 25 | 20 | 50 |
| (second) | | | | | | | |
| 4 | 70 | 10 | 7 | 10 | 8 | 5 | 60 |
| (gram) | | | | | | | |
| 5 | 10 | 25 | 100 | 180 | 240 | >360 | 20 |
| (day) | | | | | | | |
| 6 | ≧5.50 | 5 | 3 | 1 | 0.2 | 0.13 | easy to generate agglomeration |
| (μm) | | | | | | | and form irregular distributed |
| | | | | | | | aggregates because of the small |
| | | | | | | | particle size, hard film formation |
| | | | | | | | and poor film compactness |
| 7 | 10 | 15 | 25 | 30 | 30 | >40 | 20 |
| (minute) | | | | | | | |
| 8 | 2 | 4 | 5 | 8 | 10 | 10 | 0 |
| 9 | 1 | 4 | 6 | 7 | 10 | 10 | 0 |
| 10 | Unsuccessful | uniform | quite | quite | remarkably | remarkably | Unsuccessful adhesion because |
| | adhesion | basically with | uniform | uniform | uniform | uniform | of agglomeration generated |
| | | decreased adhesion | adhesion | adhesion | adhesion | adhesion | between lots of particles |

It can be concluded from the data of tests 1-10 listed in the Table, as compared to the polyether sulfone powder beyond the range of the particle sizes of the present invention, the polyether sulfone powder within the particle sizes of the present invention (larger than 0.1 μm and smaller than or equal to 5 μm) has an excellent hydrophilic property and is more easy to blend with the water and more unlikely to form agglomerates; the dosage of organic solvent could be significantly reduced; the coating prepared by the polyether sulfone ultrafine powder of the present invention are more easy to form film, meanwhile stable during long-term storage. The film formed by the coating of the present invention could achieve more excellent corrosion resistance; it could significantly improve the surface finish of plastic plate and glass when the polyether sulfone ultrafine powder of the present invention is used as plastic and glass modifier. In addition, the polyether sulfone ultrafine powder of the present invention is more easy to mix evenly with other materials (polytetrafluoroethylene resin).

Especially for the polyether sulfone ultrafine powder with particle size larger than 0.1 μm and smaller than or equal to 1 μm, it is more easy to mix evenly with other materials (polytetrafluoroethylene resin), more easy to blend with water, more unlikely to form agglomerates, and more stable when it dissolved, compared to the polyether sulfone ultrafine powder of particle size beyond the range.

### Comparison Example

It is proved by the experiments that the water-soluble coating of the present invention is remarkably superior to the traditional polyamide-imide (PAI) coating in alkali resistance, salt resistance and stiffness.

(1) Saline Immersion Experiment

Coat the workpiece with polyamide-imide (PAI) coating prepared by traditional methods and with the water-soluble coatings 1-3 of the present invention respectively under the same coating procedures; after curing and film-forming, immerse the workpiece in 5 wt % aqueous sodium chloride solution and record the time of corrosion occurrence.

The coatings 1-3 are synthesized by polyether sulfone ultrafine powder of the present invention, whose particle size is 2.5 μm, according to following formulation:

(i) Water-Soluble Coating 1:

polyether sulfone ultrafine powder 30 parts by weight;

polytetrafluoroethylene resin 15 parts by weight;

titanium green 15 parts by weight;

water 50 parts by weight; and

a mixed solvent of acetamide-pyrrolidone with a volume ratio of 1:1 10 parts by weight.

(ii) Water-Soluble Coating 2:

polyether sulfone ultrafine powder 25 parts by weight;

polytetrafluoroethylene resin 10 parts by weight;

titanium green 10 parts by weight;

water 40 parts by weight; and

a mixed solvent of acetamide-pyrrolidone with a volume ratio of 1:1 15 parts by weight.

(iii) Water-Soluble Coating 3:

polyether sulfone ultrafine powder 20 parts by weight;

polytetrafluoroethylene resin 5 parts by weight;

titanium green 5 parts by weight;

water 30 parts by weight; and

a mixed solvent of acetamide-pyrrolidone with a volume ratio of 1:1 20 parts by weight.

It is found out that polyamide-imide (PAI) coating prepared by traditional methods can be preserved for 7 days, while the water-soluble coatings 1-3 of the present invention could be preserved for a similar duration with an average of 15 days.

(2) Alkali Resistance Experiment

Coat the workpiece with polyamide-imide (PAI) coating prepared by traditional methods and with the water-soluble coatings 1-3 (prepared by the same formulation in the above-mentioned saline immersion experiment) of the present invention respectively under the same coating procedures; after curing and film-forming, immerse the workpiece in 3 wt % aqueous sodium hydroxide solution and record the time of corrosion occurrence.

It is found out that polyamide-imide (PAI) coating prepared by traditional methods can be preserved for 5 days, while the water-soluble coatings 1-3 of the present invention could be preserved for a similar duration with an average of 15 days.

(3) Abrasion Resistance Experiment

Coat the workpiece with polyamide-imide (PAI) coating prepared by traditional methods and with the water-soluble coatings 1-3 (prepared by the same formulation in the above-mentioned saline immersion experiment) of the present invention respectively under the same coating procedures; after curing and film-forming, conduct the abrasion resistance experiment by loading weight as much as 5 kg on the workpiece with rotary friction and record the friction rotational speed.

It is found out that polyamide-imide (PAI) coating prepared by traditional methods can withstand a rotational speed of 300 rpm, while the water-soluble coatings 1-3 of the present invention share similar performance with a rotational speed of more than 1000 rpm.

Above is an elaborated explanation of the present invention with detailed description of preferred embodiments, while the scope of the present invention should not be limited to the disclosed embodiments. For those who are skilled in the field, it is easy to make some modification and various modifications and similar arrangements included within the spirit and scope of the appended claims which are to be accorded with the broadest interpretation so as to encompass all such modifications and similar structures.

1. A use of polyether sulfone ultrafine powder as a glass modifier, wherein 10 wt %-30 wt % of the polyether sulfone ultrafine powder is added to a plastic or a glass corresponding to a weight of the plastic or the glass to be modified, and wherein a particle size of the polyether sulfone ultrafine powder is larger than 0.1 μm and smaller than or equal to 1 μm.

2. The use of polyether sulfone ultrafine powder according to claim 1, wherein the particle size of the polyether sulfone ultrafine powder is larger than 0.1 μm and smaller than or equal to 0.5 μm.

3. The use of polyether sulfone ultrafine powder according to claim 2, wherein the particle size of the polyether sulfone ultrafine powder is larger than 0.1 μm and smaller than or equal to 0.2 μm.

4. The use of polyether sulfone ultrafine powder according to claim 3, wherein the particle size of the polyether sulfone ultrafine powder is larger than 0.1 μm and smaller than or equal to 0.15 μm.

5. The use of polyether sulfone ultrafine powder according to claim 4, wherein the particle size of the polyether sulfone ultrafine powder is 0.13 μm.

6. The use of polyether sulfone ultrafine powder according to claim 1, wherein 15 wt %-25 wt % of the polyether sulfone ultrafine powder is added to the plastic or the glass corresponding to the weight of the plastic or the glass to be modified.

7. The use of polyether sulfone ultrafine powder according to claim 6, wherein the particle size of the polyether sulfone ultrafine powder is larger than 0.1 μm and smaller than or equal to 0.5 μm.

8. The use of polyether sulfone ultrafine powder according to claim 7 the particle size of the polyether sulfone ultrafine powder is larger than 0.1 μm and smaller than or equal to 0.2 μm.

9. The use of polyether sulfone ultrafine powder according to claim 8 the particle size of the polyether sulfone ultrafine powder is larger than 0.1 μm and smaller than or equal to 0.15 μm.

10. The use of polyether sulfone ultrafine powder according to claim 9 the particle size of the polyether sulfone ultrafine powder is 0.13 μm.

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)
